(19) United States
(12) Patent Application Publication
(10) Pub. No.: US 2015/0189722 A1
(43) Pub. Date: Jul. 2, 2015

(54) LIGHTING MODULE HAVING SURFACE LIGHT SOURCE AND LIGHTING SYSTEM

(71) Applicant: Takeshi Nakamura, Kawasaki-shi (JP)

(72) Inventor: Takeshi Nakamura, Kawasaki-shi (JP)

(73) Assignee: PIONEER CORPORATION, Kawasaki-shi, Kanagawa (JP)

(21) Appl. No.: 14/416,427

(22) PCT Filed: Jul. 24, 2012
(86) PCT No.: PCT/JP2012/068688

§ 371 Date: Jan. 22, 2015

(51) Int. Cl. H05B 37/02; H05B 33/08

(52) U.S. Cl. CPC H05B 37/0254; H05B 33/0896

(57) ABSTRACT

A lighting module includes: a surface light source; a drive control section receiving a light emission control command transmitted from a master device via a communication line, and driving and controlling the surface light source in accordance with control data for its own, the control data being included in the received light emission control command; and an ON-OFF switch to be connected to the communication line, wherein the ON-OFF switch is joined integrally with the surface light source and the drive control section.

### TECHNICAL FIELD

The present invention relates to a plurality of lighting modules having a surface light source, and a lighting system including a master device that controls a plurality of lighting modules.

### BACKGROUND ART

There has been proposed a light-emitting device using an organic EL panel which has an organic EL element as a light source. The light-emitting device using an organic EL panel is characterized by surface light emission so that the device is free from restrictions on shape. Since such characteristic cannot be found in other light-emitting devices, such as LED (light-emitting diode) light-emitting devices, further development of the light-emitting device using an organic EL panel is being expected for future application.

Generally, an organic EL panel as a light source of a light-emitting device includes an anode formed from a transparent conductive film such as ITO formed on a transparent substrate, a cathode formed from a metal such as Al, and an organic light-emitting functional layer with an organic multilayer structure, the organic light-emitting functional layer being interposed in between the anode and the cathode (Patent Literature 1). The organic light-emitting functional layer is formed from an organic material and is a laminate including, for example, a hole injection/transport layer, a light-emitting layer, an electron transport layer, and an electron injection layer laminated in this order from the anode side. These layers may be formed by, for example, a vacuum deposition method or an inkjet method. Such an organic EL panel has the organic light-emitting function layer formed into a stripe shape so that the entire panel can provide high brightness.

Two-dimensionally arranging (tiling) such plurality of organic EL panels can generate new lighting forms, such as a light-emitting ceiling or a light-emitting wall. It is expected, therefore, that a new value is offered to our daily life.

One of the lighting forms provided by tiling is to simultaneously turn on or off all the organic EL panels. This form can easily be implemented by turning on and off the power source of all the organic EL panels.

Other lighting forms may involve individually controlling a plurality of organic EL panels to achieve stage-effect lighting with use of the entire ceiling or the entire wall. For example, two-dimensional significant information and patterns can be expressed by controlling brightness and color in each organic EL panel.

There is a DMX512-A standard for a lighting control technology suitable for controlling an organic EL panel which performs such stage-effect lighting.

A lighting system using the DMX512-A standard is premised on the configuration which includes one master device that manages lighting control and a plurality of lighting modules (slave devices) subjected to the lighting control. If the DMX512-A standard is applied to the lighting system having a plurality of organic EL panels tiled as described above, the master device transmits a command including control data to each of the plurality of lighting modules via a communication line. Upon reception of the command, each of the plurality of lighting modules including an organic EL panel drives the organic EL panel according to the control data included in the command.

### CITATION LIST

### Patent Literature

Patent Literature 1: Japanese Patent No. 4567092

### SUMMARY OF INVENTION

### Technical Problem

However, in the lighting system using the DMX512-A standard, different addresses need to be assigned to the respective lighting modules so that each of the plurality of lighting modules is identified. In conventional lighting systems, a dip switches or a rotary switch is generally used to set an address for each of the plurality of lighting modules. Since this address setting method requires manual operation, it is not difficult to imagine that the operation would be laborious as the number of lighting modules increases. Moreover, since errors such as address duplication tend to occur in the operation where address values are set by hand, it would also be laborious to perform error check operation.

There is still another problem besides the tedious manual address setting. As described in the foregoing, one of the important application forms of the surface light panels like the organic EL panels is tiling. A user sees only the light-emitting surface of the tiled organic EL panels. Accordingly, components in the lighting modules, such as aforementioned switches, drive control sections of the panels, and wirings, need to be constructed on the rear side of the panels, that is, for example, inside the ceiling, so as to be hidden from the users. This brings about such disadvantage that the address setting operation needs to be completed before installing the lighting modules on their intended surfaces and that the address setting and/or change are difficult after the lighting modules are installed.

In addition, it is understood that it may not be sufficient to simply set individual addresses. There is no need to say that intended stage-effect lighting cannot be realized properly unless the correspondence between the position and address of each tiled lighting module is completely recognized by the master device or the user.

Accordingly, the aforementioned disadvantage may be one example of the problems to be solved by the present invention. An object of the present invention is to provide a lighting module and a lighting system capable of assigning addresses to respective lighting modules so that the correspondence between the position and address of each lighting module is clarified by simple manual operation.

### Solution to Problem

A lighting module of the invention according to claim 1 includes: a surface light source; and a drive control section receiving a light emission control command transmitted from a master device via a communication line and driving and controlling the surface light source in accordance with control data for its own, the control data being included in the received light emission control command, the lighting module comprising an ON-OFF switch to be connected to the communication line, the ON-OFF switch being joined integrally with the surface light source and the drive control section.

A lighting system of the invention according to claim 8 includes: a master device for transmitting a light emission control command; and a plurality of lighting modules, each having a surface light source, receiving the light emission control command transmitted from the master device via a communication line, and driving and controlling the surface light source in accordance with control data for its own, the control data being included in the received light emission control command, the lighting system comprising: transmitting means provided in the master device to sequentially set addresses with specified timing and to transmit an address assignment command including a set address to the communication line; and switching means for setting one lighting module out of the plurality of lighting modules in synchronization with the specified timing, the one lighting module being put in a command receivable state in a predetermined order, wherein each of the plurality of lighting modules has acquisition means for receiving the address assignment command and acquires the address included in the address assignment command when each of the lighting modules is set as the one lighting module by the switching means, and extraction means for extracting the control data for its own from the light emission control command in accordance with the address acquired by the acquisition means.

### BRIEF DESCRIPTION OF DRAWINGS

FIG. 1 is a block diagram illustrating a lighting system of an embodiment of the present invention.

FIG. 2 is a cross sectional view of a surface light source in the lighting module of FIG. 1.

FIG. 3 is a diagram illustrating a command format for asynchronous serial communication used in the lighting system of FIG. 1.

FIG. 4 is a diagram illustrating a command format of an original command of the DMX512-A standard used in the lighting system of FIG. 1.

FIG. 5 is a sequence diagram of address assignment operation of the lighting system of FIG. 1.

FIG. 6 a diagram illustrating a command format for a command used in an address mode.

FIG. 7 a diagram illustrating types of the commands illustrated in FIG. 6 and contents of respective parameters for each type.

FIG. 8 illustrates a command format for DMX commands.

### DESCRIPTION OF EMBODIMENT

Hereinbelow, an embodiment of the present invention will be described in detail with reference to the accompanying drawings.

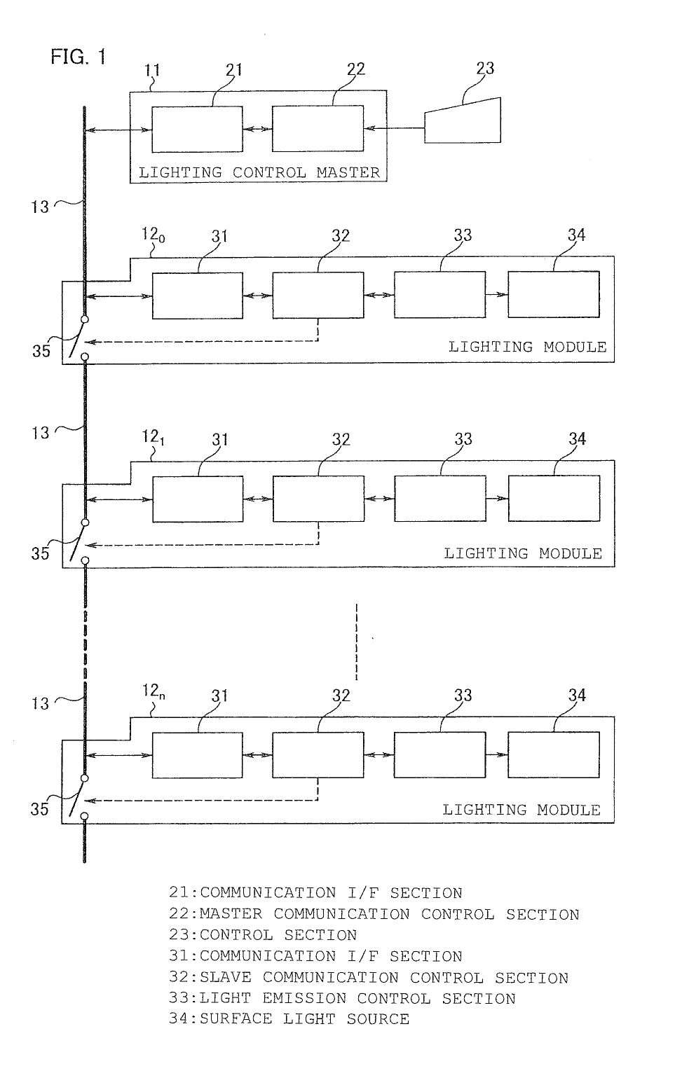

A lighting system of the embodiment illustrated in FIG. 1 includes a lighting control master 11 (master device), a plurality of lighting modules (slave devices) 12₀ to 12ₙ (where n is a positive integer), and a communication line 13 provided between the lighting control master 11 and the plurality of lighting modules 12₀ to 12ₙ.

The lighting control master 11 is a controller that controls operation of each of the plurality of lighting modules 12₀ to 12ₙ. The lighting control master 11 has a communication I/F (interface) unit 21, and a master communication control section 22. The communication I/F unit 21 is connected to the communication line 13 to transmit and receive later-described commands to/from each of the plurality of lighting modules 12₀ to 12ₙ. The master communication control section 22 is connected to the communication I/F unit 21. The master communication control section 22 is constituted by, for example, a microcomputer which generates commands for controlling the operation of each of the plurality of lighting modules 12₀ to 12ₙ. The master communication control section 22 supplies the generated commands to the communication I/F section 21 so that the commands are transmitted. The master communication control section 22 also interprets the content of a command that the communication I/F section 21 received, and generates a command in response thereto.

An operation section 23 is connected to the master communication control section 22. The operation section 23 accepts input operation by a user and issues a command corresponding to the input operation to the master communication control section 22. Although the operation section 23 is provided outside the lighting control master 11 in the embodiment, the operation section 23 may be provided as a part of the lighting control master 11.

Each of the plurality of lighting modules 12₀ to 12ₙ is tiled on a ceiling, a wall, or the like as an organic EL panel having a surface light source 34 which is formed from a later-described organic EL element. The plurality of lighting modules 12₀ to 12ₙ have the same configuration including a communication I/F (interface) unit 31, a slave communication control section 32, a light emission control section 33, and a surface light source 34. The communication I/F section 31, the slave communication control section 32, and the light emission control section 33 constitute a drive control section of the surface light source 34.

The communication I/F section 31 is connected to the communication line 13 and transmits and receives commands to/from the lighting control master 11. The slave communication control section 32 is separately connected to the communication I/F section 31 and to the light emission control section 33. The slave communication control section 32 extracts control data addressed to the subject lighting module from the command received by the communication I/F section 31, and supplies the control data to the light emission control section 33. The slave communication control unit 32 also interprets the content of the command that the communication I/F section 31 received, and generates a command in response thereto. The light emission control section 33 is connected to the surface light source 34. The light emission control section 33 drives and controls the surface light source 34 in accordance with the control data supplied from the slave communication control section 32. For example, the slave communication control section 32 and the light emission control section 33 may be configured by a single microcomputer.

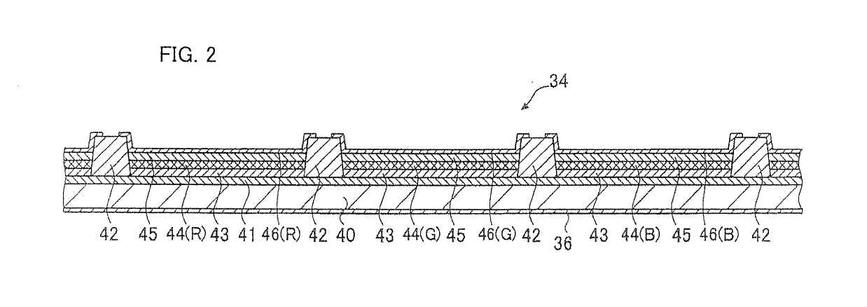

As illustrated in FIG. 2, the surface light source 34 is configured so that a transparent electrode 41 is formed as an anode on a glass substrate 40. For example, the transparent electrode 41 is formed from an ITO film by sputtering. On the transparent electrode 41, a plurality of elongated banks 42 are arranged in parallel at regular intervals. The banks 42 are formed from an organic insulating material. The organic insulating material is applied on the transparent electrode 41 by a spin coating method or a printing method. After being dried, the organic insulating material is patterned with a photolithography technique to form the banks 42. The banks 42 have a trapezoidal cross section in a direction perpendicular to their longitudinal direction, and therefore have a forward tapered shape on the transparent electrode 41. Unillustrated bus lines for feeding power are formed on the transparent electrode 41 at the positions where the banks 42 are formed, so that the bus lines are covered with the banks 42.

The above-stated light-emitting area is positioned between the adjacent banks 42. In each of the light-emitting areas, a hole injection layer 43, a light-emitting layer 44, and an electron injection layer 45 are formed in this order as an organic light-emitting structure layer. To form each of the hole injection layer 43, the light-emitting layer 44, and the electron injection layer 45, inks containing their respective materials are applied by an application method such as an inkjet method, and then the inks are dried after the application. As for the light-emitting layer 44, the light-emitting layers 44 different in color from each other are placed in adjacent light-emitting areas. A red light-emitting layer 44 (R), a green light-emitting layer 44 (G), and a blue light-emitting layer 44 (B) are repeatedly placed in this order in the direction in which the banks 42 are placed side by side. Without being limited to the aforementioned configuration, the organic light-emitting structure layer may have a hole transport layer formed between the hole injection layer 43 and the light-emitting layer 44, and an electron transport layer formed between the light-emitting layer 44 and the electron injection layer 45.

For example, an Al film is vacuum-deposited on the electron injection layer 45 by, for example, the vacuum deposition method. The Al film is further patterned with the photolithography technique so that metal electrodes 46 (R), 46 (G), and 46 (B) are formed as a cathode for each of RGB colors.

The light emission control section 33 individually supplies a driving current to between the transparent electrode 41 and each of the metal electrodes 46 (R), 46 (G) and 46 (B). Levels of the respective driving currents are determined in accordance with the above-described control data. In the light-emitting area, light is emitted with the brightness corresponding to the levels of the driving currents.

When the light-emitting layers 44 (44 (R), 44 (G) and 44 (B)) of the surface light source 34 emit light, the light goes out through the hole injection layer 43, the transparent electrode 41, and the glass substrate 40. The light generated in the light-emitting layer 44 passes through the electron injection layer 45 and is reflected by the metal electrodes 46 (46 (R), 46 (G), and 46 (B)). The reflected light goes out through the electron injection layer 45, the light-emitting layer 44, the hole injection layer 43, the transparent electrode 41, and the glass substrate 40. The outgoing light is the mixture of red light, green light, and blue light mixed based on the brightness of the respective colors. When the red light, the green light, and the blue light have the same brightness, the light goes out as white light.

Each of the plurality of lighting modules 12₀ to 12ₙ further has an ON-OFF switch 35. In each of the lighting modules 12₀ to 12ₙ, the ON-OFF switch 35 is joined integrally with the surface light source 34 and the aforementioned drive control section. For example, the ON-OFF switch 35, the surface light source 34, and the drive control section are formed on the same substrate. All the ON-OFF switches 35 in the lighting modules 12₀ to 12ₙ serve as the switching means.

ON/OFF control of the switch 35 is performed by the slave communication control section 32. The switch 35 is connected to the communication line 13. The plurality of lighting modules 12₀ to 12ₙ, from the lighting module 12₀ to the lighting module 12ₙ, are connected to the lighting control master 11 in a daisy chain. The communication line 13 connects between the lighting control master 11 and the plurality of lighting modules 12₀ and between each of the plurality of lighting modules 12₀ to 12ₙ. The switch 35 has two terminals (one end and the other end). In each of the plurality of lighting modules 12₀, one end of the switch 35 is connected to the upstream part of the communication line 13 at the side of the lighting control master 11 while the other end is connected to the downstream part of the communication line 13. The lighting control master 11 is connected to one end of the switch 35 of the lighting module 12₀ via the communication line 13, while the other end of the switch 35 of the lighting module 12₀ is connected to one end of the switch 35 of the lighting module 12₁ via the communication line 13. The other end of the switch 35 of the lighting module 12₁ is connected to one end of the switch 35 of the lighting module 12₂ via the communication line 13. One end of the switch 35 of the subsequent lighting module 12ₙ is similarly connected. In each of the lighting modules 12₀ to 12ₙ, the aforementioned communication I/F section 31 is connected to one end of the switch 35 which is at the upstream side of the communication line 13.

In the lighting system having such a configuration, the lighting control master 11 controls the plurality of lighting modules 12₀ to 12ₙ by using a communications protocol called the DMX512-A standard as described in the foregoing.

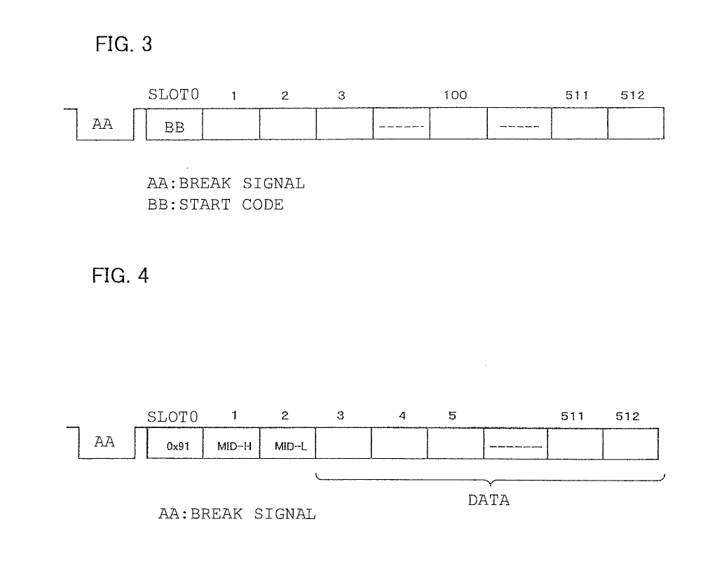

The DMX512-A standard adopts an EIA-485 standard (=RS-485 standard) as an electric specification of the communication line. According to the EIA-485 standard, asynchronous serial communication is performed. The asynchronous serial communication has a command format with a simple packet configuration as illustrated in FIG. 3. The command format includes a start signal called a break signal, a 1-byte start code (slot 0), and a subsequent 512-bytes data part (slots 1 to 512). Generally, the start code=0x00 is used. This code is called a null command to be used for performing lighting control and various device controls.

A function to transmit original commands is also provided. As illustrated in FIG. 4, a start code of 0x91 and a 2-byte Manufacturer ID to identify company and organization are transmitted, followed by data (=original command) in the subsequent slots. MID-H is an upper byte of the MID, and MID-L is a lower byte of the MID.

In the case of controlling a plurality of apparatuses using the DMX512-A standard, a value called DMX address is set for each apparatus. Data on a slot position that is equivalent to this DMX address is used to instruct each individual apparatus. That is, when instructing each of the apparatuses takes 1 byte, maximum 512 apparatuses can be controlled.

Therefore, in the lighting system of the embodiment, it is necessary to assign (allocate) DMX addresses to the lighting modules 12₀ to 12ₙ in advance so that the lighting control master 11 controls each of the lighting modules 12₀ to 12ₙ to be controlled.

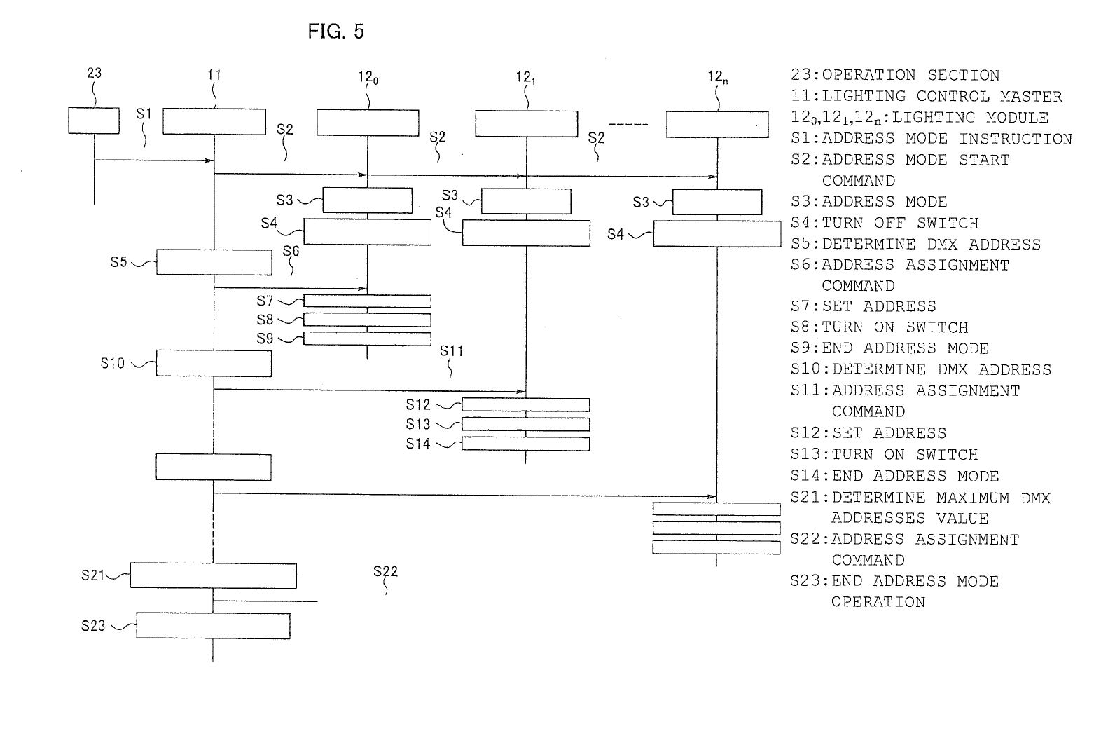

Now, the assignment operation of the DMX addresses will be described with reference to a sequence diagram of FIG. 5.

In starting the operation to assign the DMX addresses, the entire lighting system is first set to be in an address mode. That is, when the user performs input operation to the operation section 23, an address assignment command is generated by the operation section 23 (step S1). In response to the address assignment command, the master communication control section 22 generates an address mode start command for each of the plurality of lighting modules 12₀ to 12ₙ. The generated address mode start command is passed to the communication I/F unit 21, and is transmitted to each of the lighting modules 12₀ to 12ₙ by the communication I/F unit 21 via the communication line 13 (step S2).

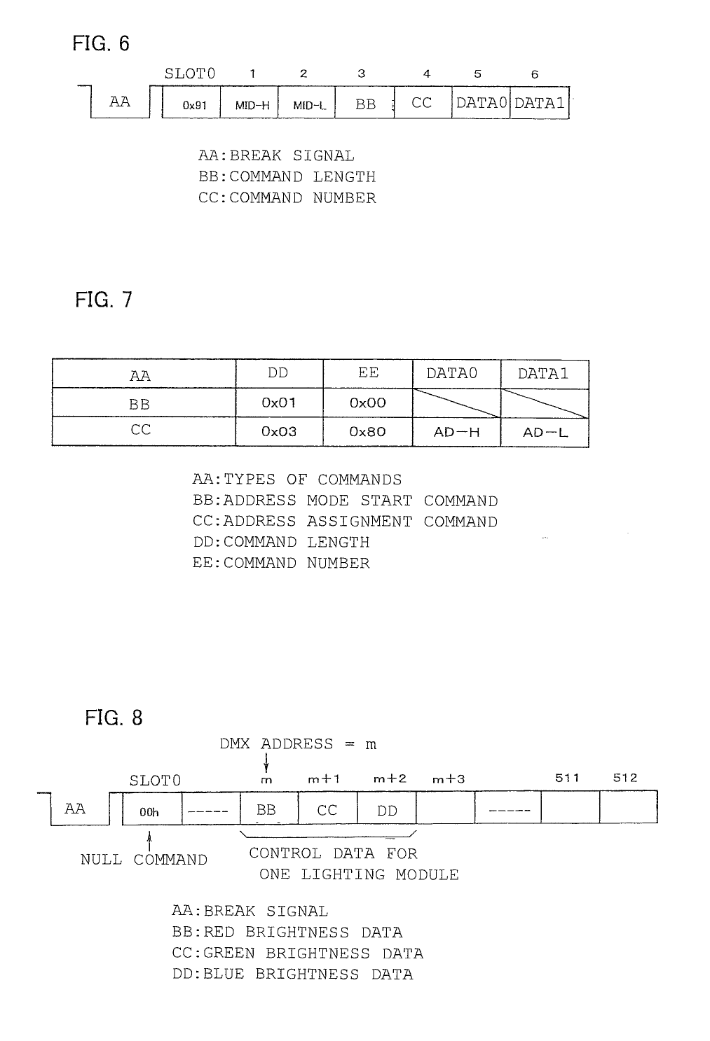

The command to be used at this point has an original command format in conformity with the aforementioned DMX512-A standard. As illustrated in FIG. 6, Slot 0 to Slot 2 are identical to those illustrated in FIG. 4. Slot 3 stores a command length (number of bytes), and slot 4 stores the content of the command. As illustrated in FIG. 7, for the start of the address mode, the command length in Slot 3 is 0x01 and the command number in Slot 4 is 0x00.

This original command format is used not only in the address mode start command but also in an address assignment command as is clear from FIG. 7. In the address assignment command, the command length is 0x03, and Slots 5 and 6 are used. Slot 5 is the upper 8 bits (AD-H) of a DMX address, and Slot 6 is the lower 8 bits (AD-L) of the DMX address. The commands described herein are used in the address mode. The commands are not only transmitted from the lighting control master 11 but also transmitted from the lighting modules 12₀ to 12ₙ.

In each of the lighting modules 12₀ to 12ₙ, the communication I/F section 31 receives the address mode start command transmitted from the lighting control master 11. The received command is supplied to the slave communication control section 32. When the slave communication control section 32 detects 0x91 stored in Slot 0 of the command, which indicates an original command, the slave communication control section 32 sets the operation mode of the lighting module to the address mode, in accordance with the command number 0x00 in the subsequent Slot 4 (step S3).

In the address mode, the slave communication control section 32 first turns off the ON-OFF switch 35 in each of the plurality of lighting modules 12₀ to 12ₙ (step S4). After execution of step S4, the lighting control master 11 is communicably connected only to the lighting module 12₀ via the communication line 13. More specifically, the lighting module 12₀ is set as the one lighting module.

In the address mode, the master communication control section 22 in the lighting control master 11 determines the DMX address (step S5). The value of each DMX address is determined so as to sequentially ascend with predetermined timing after the address mode is started. Then, an address assignment command including the determined DMX address is generated. The address assignment command includes the upper 8 bits (AD-H) of the DMX address in Slot 5 and the lower 8 bits (AD-L) of the DMX address in Slot 6 as described above.

The generated address assignment command is passed to the communication I/F unit 21, and is output to the communication line 13 by the communication I/F unit 21 (step S6). In this case, since the communication line 13 is connected only to the lighting module 12₀ among the lighting modules 12₀ to 12ₙ, the address assignment command is transmitted to the lighting module 12₀. Determination of the DMX address in step S5 and transmission of the address assignment command in step S6 correspond to the transmitting means.

In the lighting module 12₀, the communication I/F section 31 receives the address assignment command transmitted from the lighting control master 11. The received command is supplied to the slave communication control section 32. When the slave communication control section 32 confirms that the command is an address assignment command in accordance with Slot 0 to Slot 4 in the supplied command, the slave communication control section 32 extracts the DMX address from Slot 5 and Slot 6, and sets it as the address of its own (step S7). The slave communication control section 32 then turns on the switch 35 (step S8), and ends the address mode of the lighting module 12₀ (step S9). In setting of the address of its own in step S7, the DMX address is stored in a memory, for example. Since the switch 35 in the lighting module 12₀ is turned on in step S8, the lighting control master 11 is communicably connected only to the lighting modules 12₀ and 12₁ via the communication line 13. Once the address mode is ended in step S9, an address assignment command, if received, is ignored by the slave communication control section 32 in the lighting module 12₀. Extraction of the address from the address assignment command in step S7 corresponds to the acquisition means.

After the operation of steps S7 to S9 in the lighting module 12₀ is completed, the master communication control section 22 determines the next DMX address in the lighting control master 11 (step S10). A duration of time from step S6 where the master communication control section 22 transmits the address assignment command, to step S10 where the master communication control section 22 starts determination of the next DMX address, is larger than the total operation time of steps S7 to S9 in the lighting module 12₀.

The address assignment command generated in step S10 is passed to the communication I/F unit 21, and is output to the communication line 13 by the communication I/F unit 21 (step S11). In this case, the communication line 13 extending from the lighting control master 11 is connected only to the lighting modules 12₀ and 12₁ among the lighting modules 12₀ to 12ₙ. Consequently, the address assignment command is transmitted to the lighting modules 12₀ and 12₁. However, since the address mode is ended in the lighting module 12₀ as described above, the address assignment command is ignored in the lighting module 12₀.

In the lighting module 12₁, the communication I/F section 31 receives the address assignment command transmitted from the lighting control master 11. The received command is supplied to the slave communication control section 32. When the slave communication control section 32 confirms that the command is an address assignment command in accordance with Slot 0 to Slot 4 in the supplied command, the slave communication control section 32 extracts the DMX address from Slot 5 and Slot 6, and sets it as the address of its own (step S12). The slave communication control section 32 then turns on the switch 35 (step S13), and ends the address mode of the lighting module 12₁ (step S14). Operation in steps S12 to S14 is identical to the operation in steps S7 to S9 in the lighting module 12₀.

Thus, the subsequent lighting modules 12₂ to 12ₙ receives an address assignment command transmitted from the lighting control master 11 in this order, and the same operation as in steps S7 to S9 is performed.

In the lighting control master 11, the master communication control section 22 keeps on determining the DMX address up to a maximum assignable address value with the aforementioned predetermined timing. The number of the DMX addresses to be determined is n+1 or more where n designates the number in the lighting modules 12₀ to 12ₙ. The master communication control section 22 then determines the maximum. DMX address value (step S21), and makes the communication I/F unit 21 output the number to the communication line 13 (step S22). Then the master communication control section 22 ends the operation of the address mode (step S23).

In the case where the master communication control section 22 knows n+1 where n is the number in the lighting modules 12₀ to 12ₙ, the master communication control section 22 may determine the maximum DMX address value assignable to the lighting modules 12n, make the communication I/F unit 21 output the number to the communication line 13, and may end the operation of the address mode.

Once the address mode is ended, the operation mode of the lighting modules to which the DMX addresses have been set is shifted to the lighting control mode. In the lighting control mode, commands are typically transmitted only from the lighting control master 11 to the lighting modules 12₀ to 12ₙ.

In the lighting system of the embodiment, the brightness of RGB colors is specified by using total 3 bytes, 1 byte being used for each color. Therefore, three slots of the DMX command that is a light emission control command are used for storing control data on one lighting module. In this case, as illustrated in FIG. 8, Slot m stores red brightness data, Slot m+1 stores green brightness data, and Slot m+2 stores blue brightness data. As the DMX address, Slot m which is the top of these three slots is specified. The number of maximum connectable apparatuses is 512/3=170.6 . . . , that is, up to n=170 of lighting modules 12₀ to 12ₙ may be used.

When the user performs input operation to the operation section 23 in the lighting control mode, a mixing instruction is generated in the operation section 23. In response to the mixing instruction, the master communication control section 22 in the lighting control master 11 generates a DMX command including RGB color mixing data for each of the plurality of lighting modules 12₀ to 12ₙ, i.e., for each of the DMX addresses. This DMX command has a data format illustrated in FIG. 8. The DMX command is transmitted to the respective lighting modules 12₀ to 12ₙ by the communication I/F unit 21 via the communication line 13.

In each of the lighting modules 12₀ to 12ₙ, the communication I/F section 31 receives the DMX command transmitted from the lighting control master 11. The received DMX command is supplied to the slave communication control section 32. When the slave communication control section 32 detects that Slot 0 in the DMX command indicates a null command, the slave communication control section 32 extracts data from consecutive three slots in the DMX command, which corresponds to the DMX address of its own set in the above-stated steps, such as steps S7 and S12. The data is extracted as red brightness data, green brightness data, and blue brightness data (the operation corresponds to the extraction means that extracts control data). The brightness data on those RGB (red, green, and blue) colors is supplied to the light emission control section 33. The light emission control section 33 supplies the driving current, the value of which corresponds to the red brightness data, to between the transparent electrode 41 and the metal electrode 46 (R) of the surface light source 34. The light emission control section 33 supplies the driving current, the value of which corresponds to the green brightness data, to between the transparent electrode 41 and the metal electrode 46 (G), and the driving current, the value of which corresponds to the blue brightness data, to between the transparent electrode 41 and the metal electrode 46 (B). By supplying the driving currents to the surface light sources 34, luminescent colors of the surface light sources 34 are mixed.

Thus, in the lighting system of the embodiment, the ON-OFF switch 35 is provided in each of the lighting modules 12₀ to 12ₙ. Accordingly, after each of the lighting modules 12₀ to 12ₙ is installed on a ceiling, a wall, or the like, DMX addresses can easily be assigned to the respective lighting modules 12₀ to 12ₙ. Since the DMX addresses are set in the connection order of the lighting modules 12₀ to 12ₙ connected in a daisy chain, relation between the DMX addresses and the respective lighting modules 12₀ to 12ₙ can be clarified.

Furthermore, when a lighting module is further added to the lighting modules 12₀ to 12ₙ to which the DMX addresses have been assigned, reassignment of the DMX addresses can easily be performed.

Since only the lighting control master 11 transmits commands, and the lighting modules 12₀ to 12ₙ only receive the commands, command collision cannot occur.

In the above-described embodiment, the lighting system is described in which the lighting control master 11 controls the plurality of lighting modules 12₀ to 12ₙ using the DMX512-A standard, and addresses are set for the lighting modules. However, for setting the addresses to the lighting modules, the present invention is naturally applicable to lighting systems which use standards other than the DMX512-A standard.

Furthermore, in the aforementioned embodiment, the address (DMX address) represents the slot number of the DMX command. However, the present invention is not limited to this configuration.

In the aforementioned embodiment, organic EL elements are used as a surface light source in the lighting modules. However, light-emitting elements, such as light-emitting diodes (LEDs) other than the organic EL elements, may also be used.

### REFERENCE SIGNS LIST

11 lighting control master
12₀-12ₙ, 12ₖ, 12_{end} lighting module
13 communication line
21, 31 communication I/F section
22 master communication control section
23 operation section
32 slave communication control section
33 light emission control section
34 surface light source
35 ON-OFF switch
41 transparent electrode
42 bank
43 hole injection layer
44 (R), 44 (G), 44 (B) light-emitting layer
45 electron injection layer
46 (R), 46 (G), 46 (B) metal electrode

1. A lighting module comprising:
a surface light source; and
a drive control section receiving a light emission control command transmitted from a master device via a communication line, and driving and controlling the surface light source in accordance with control data for its own, the control data being included in the received light emission control command; and
further comprising an ON-OFF switch to be connected to the communication line, wherein
the ON-OFF switch is joined integrally with the surface light source and the drive control section.

2. The lighting module according to claim 1, wherein
the master device is connected to the lighting module and other lighting modules via the communication line in a daisy chain, and
the ON-OFF switch should be inserted to between an upstream side and a downstream side of the communication line extending from the master device.

3. The lighting module according to claim 2, wherein
the drive control section has acquisition means for receiving an address assignment command transmitted from the master device and acquiring an address included in the address assignment command, and
extraction means for extracting the control data for its own from the light emission control command in accordance with the address acquired by the acquisition means.

4. The lighting module according to claim 3, wherein the ON-OFF switch is turned off until the address is acquired by the acquisition means and is turned on thereafter.

5. The lighting module according to claim 4, wherein
the light emission control command is a serial communication command having a slot sequence, and
the address is to specify one slot out of the slot sequence.

6. The lighting module according to claim 5, wherein upon reception of an address mode start command transmitted from the master device, the drive control section sets an operation mode to an address mode and turns off the ON-OFF switch.

7. The lighting module according to claim 6, wherein the drive control section ends the address mode once the address is acquired.

8. A lighting system comprising:
a master device for transmitting a light emission control command; and
a plurality of lighting modules, each having a surface light source, receiving the light emission control command transmitted from the master device via a communication line, and driving and controlling the surface light source in accordance with control data for its own, the control data being included in the received light emission control command, and
further comprising:
transmitting means provided in the master device to sequentially set addresses with specified timing and to transmit an address assignment command including a set address to the communication line; and
switching means for setting one lighting module out of the plurality of lighting modules in synchronization with the specified timing, the one lighting module being put in a command receivable state in a predetermined order, wherein
each of the plurality of lighting modules has acquisition means for receiving the address assignment command and acquiring the address included in the address assignment command when each of the lighting modules is set as the one lighting module by the switching means, and
extraction means for extracting the control data for its own from the light emission control command in accordance with the address acquired by the acquisition means.
